(19) United States
(12) Patent Application Publication
(10) Pub. No.: US 2014/0331828 A1
(43) Pub. Date: Nov. 13, 2014

(54) Method of Compensating for Adapters or Extensions on an Electronic Torque Wrench

(71) Applicants: Jerry A. King, Hacienda Hts, CA (US); Duane A. Vallejos, La Puente, CA (US); Andrew R. Lobo, Wadsworth, IL (US); Chris Lawton, Costa Mesa, CA (US); Nathan Lee, Escondido, CA (US)

(72) Inventors: Jerry A. King, Hacienda Hts, CA (US); Duane A. Vallejos, La Puente, CA (US); Andrew R. Lobo, Wadsworth, IL (US); Chris Lawton, Costa Mesa, CA (US); Nathan Lee, Escondido, CA (US)

(21) Appl. No.: 13/888,658

(22) Filed: May 7, 2013

(51) Int. Cl. B25B 23/142

(52) U.S. Cl. CPC B25B 23/1422
USPC 81/467

(57) ABSTRACT

The present disclosure relates to electronic torque tools that allow an offset length of an adapter or extension being used in conjunction with the tool to be input into the tools. The tools may also include an input for a head length, when the head of the tool is interchangeable. The tools use the input(s) to calculate a correction factor. The correction factor is used to adjust the torque measurement of the tools so that the tools display the actual torque value without the need for re-calibration or the performance of external calculations.

### TECHNICAL FIELD OF THE INVENTION

The present application relates to tools adapted to apply torque to a work piece. More particularly, the present application relates to electronic torque wrenches that can be configured with extensions and adapters.

### BACKGROUND OF THE INVENTION

Electronic torque wrenches are commonly used in automotive and industrial applications to apply a predetermined amount of torque to a work piece, such as a threaded fastener. For example, a fastening system may require tightening components such as a nut and bolt to a desired amount of torque or within a desired torque range. Securing the fastening components at a desired torque setting allows for secure attachment of the components and structures related thereto without under-tightening or over-tightening the components. Under-tightening the components could result in unintended disengagement of the components. Over-tightening the components could make disengaging the components difficult or could damage the components or fasteners. To prevent under-tightening or over-tightening a torque measurement can be made while tightening the components, for example, a nut to a bolt, to meet a target torque setting or to apply a torque within a desired torque range.

In general, torque wrenches are calibrated at a specific effective length of a moment arm between the application point of a rotating force located at the torque wrench handle and an axis of rotation through the head of the torque wrench about which the rotating force is applied. Thus, if an extension or adapter is attached or used in conjunction with the torque wrench, the amount of torque applied using a torque wrench will be different from that indicated by a reading on the torque wrench. Currently, a user of the torque wrench can compensate for the length of the adapter or extension by performing a hand calculation and converting the indicated reading on the torque wrench to an actual applied torque value. However, the calculation can be time consuming and mistakes can be made when performing the calculation. If the calculation is incorrect, the final torque applied to the fastener will be incorrect and could cause damage to the fastener and associated components.

### SUMMARY OF THE INVENTION

The present application discloses a tool, for example, a torque wrench, that allows a user to input a length, also referred to herein as an offset length, of an adapter or extension being used in conjunction with the tool. The tool can further be adapted to accept a code that identifies the extension or adapter, wherein the tool uses a look up table to automatically determine the appropriate length, so the user does not need to know the specific length of the extension or adapter. In an embodiment, the code can be imprinted on the extension or adapter or included with documentation of the extension or tool. It will be appreciated that other means of obtaining the code can be used as well without departing from the scope or spirit of the present application. The tool then uses the input length to calculate a correction factor. The correction factor is used to adjust the torque measurement of the tool so that the tool compensates for the extension or adapted and displays the actual torque value applied to the work piece without the need for re-calibration or the performance of external calculations.

In particular, the present application discloses a tool having a drive head adapted to apply a torque to a work piece, a handle extending from the drive head, and a torque sensor disposed in the tool that is adapted to measure an amount of the torque being applied from the drive head to the work piece. The tool also includes a user input interface, for example, disposed in the handle, that is adapted to receive a compensation factor of an adapter being used in conjunction with the tool. A processor is also disposed in the tool and is in operable communication with the user input interface and the torque sensor. The processor is adapted to adjust a measurement of the amount of torque to a corrected amount of torque being applied based on the amount of torque being applied and applying the compensation factor.

In an illustrative embodiment, a tool is disclosed having a receiving head, a handle extending from the receiving head, an interchangeable drive head disposed in the receiving head, and a torque sensor disposed in the tool that is adapted to measure an amount of the torque being applied to the interchangeable drive head. The tool also includes a user input interface, for example, disposed in the handle, that is adapted to receive a current head length of the interchangeable drive head. A processor is also disposed in the tool and is in operable communication with the user input interface and the torque sensor. In another embodiment, the user input interface is adapted to receive a code specific to the interchangeable drive head, wherein the processor can use a lookup table to determine the compensation factor of the specific interchangeable head that is being used. In an embodiment, the code can be imprinted on the interchangeable head or included with documentation of the interchangeable head. The tool then uses the input length to calculate a correction factor. The processor is adapted to adjust a measurement of the amount of torque to a corrected amount of torque being applied based on the amount of torque being applied to the drive head and applying the compensation factor based on the current head length.

In another embodiment, a method of adjusting a torque measurement of a tool is disclosed. The method includes displaying a menu on a display of the tool, receiving an offset of an adapter coupled to the tool via an interface of the tool, and applying a compensation factor to the amount of torque being applied based, at least in part, on the offset of the adapter. The compensation factor is used to adjust the torque measurement of the tool to a corrected torque measurement, and the corrected torque measurement is displayed on the display of the tool. This allows the tool to display the actual torque amount being applied to a work piece without the need for re-calibration or the performance of external calculations.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 illustrates a top plan view of a tool in accordance with an embodiment of the present application.

FIG. 2 illustrates a schematic functional block diagram of a controller of the tool in accordance with an embodiment of the present application.

FIG. 3 illustrates a side elevation view of the tool of FIG. 1 with a first exemplar extension in accordance with an embodiment of the present application.

FIG. 4 illustrates a side elevation view of the tool of FIG. 1 with a second exemplar extension in accordance with an embodiment of the present application.

FIG. 5 illustrates a top plan view of the tool of FIG. 1 with a third exemplar extension in accordance with an embodiment of the present application.

FIG. 6 illustrates a block diagram of a process in accordance with an embodiment of the present application.

FIG. 7 illustrates an exemplar display sequence of a tool in accordance with an embodiment of the present application.

FIG. 8 illustrates a side elevation view of a tool with an exemplar interchangeable head in accordance with an embodiment of the present application.

FIG. 9 illustrates a side elevation view of the tool of FIG. 2 with the interchangeable head and an exemplar extension in accordance with an embodiment of the present application.

FIG. 10 illustrates a block diagram of a process in accordance with an embodiment of the present application.

FIG. 11 illustrates an exemplar display sequence of a tool with an interchangeable head in accordance with an embodiment of the present application.

FIG. 12 illustrates a block diagram of an exemplar set-up process of a tool in accordance with embodiment of the present application.

It should be understood that the comments included in the notes as well as the materials, dimensions and tolerances discussed therein are simply proposals such that one skilled in the art would be able to modify the proposals within the scope of the present application.

### DETAILED DESCRIPTION OF THE EMBODIMENTS

While this invention is susceptible of embodiments in many different forms, there is illustrated in the drawings, and herein described in detail, an embodiment of the invention with the understanding that the present disclosure is to be considered as an exemplification of the principles of the invention and is not intended to limit the broad aspect of the invention to embodiments illustrated.

The present application discloses electronic torque tools that allow a user to adjust the torquing length, also referred to herein as an offset length, of an adapter or extension being used in conjunction with the tool. The tools may also include an input for a head length, when the head of the tool is interchangeable. The tools may also include an input for a code specific to the adapter or extension, or interchangeable head, wherein the tool can utilize a lookup table to automatically determine the offset length. In an embodiment, the code can be imprinted on the extension, adapter, or interchangeable head or included with documentation of the extension or tool. It will be appreciated that other means of obtaining the code can be used as well without departing from the scope or spirit of the present application. The tool then uses the input length to calculate a correction factor. The tools then use the offset length to calculate a correction factor. The correction factor is used to adjust the torque measurement of the tools so that the tools display the actual amount of torque being applied without the need for re-calibration or the performance of external calculations.

As illustrated in FIG. 1, a tool 100 is disclosed. As shown herein, the tool 100 is depicted as a well-known electronic torque wrench, but it will be understood that the present application can be used with any type of tool that is adapted to apply torque to a work piece, such as, for example, a threaded fastener. In an embodiment, the tool 100 includes a handle 102 and a drive head 104. The handle 102 includes a shaft 106 and can include a grip 108 for gripping the handle 102 by a user. Although the grip 108 is illustrated as being located at an end of handle 102, the grip may be positioned at other locations along the handle 102, or alternately, the handle 102 may be fitted with two or more grips for gripping.

The drive head 104 of the tool 100 can include a receiving area or drive lug that, directly or indirectly, applies torque to a work piece. For example, the drive head 104 can be coupled to a socket that is adapted to couple to a hex-bolt fastener to apply torque to the fastener in a well-known manner. The drive head 104 can also include a reversing lever (not shown) and a pivot joint 110. The reversing lever may be connected to a pawl (not shown) to selectively operate the tool 100 in a predetermined drive direction in a well-known manner. The pivot joint 110 may allow the handle 102 to pivot relative to the head 104 to make usability easier for certain fasteners located in hard to reach areas, for example.

The tool 100 further includes a controller 112 operatively associated with the tool, for example, being disposed in or fixedly attached to the handle 102. The controller 112 may include a display 114 for displaying information related to a torque application, to be described more fully hereinafter. The controller 112 also includes a user input interface 116 for inputting instructions and modifying settings of the tool or interacting with menus presented on the display 114.

The user input interface 116 allows the user to input information, data, and/or commands into the tool 100. By way of example, the user input interface 116 can include a keyboard, mouse, touch screen, audio recorder, audio transmitter, member pad, or other device that allows for the entry of information from a user. As illustrated in FIG. 1, in an embodiment, the user input interface 116 can include buttons 118, e.g., up/down control buttons, an “enter” key, a “units” key and other buttons. In one example, the buttons 118 allow the user to input an offset length or length of an adapter or extension.

In an illustrative embodiment, the display 114 can display various information for the user to view and interpret, for example, text or graphics, or information entered into the user input interface 114. By way of example, the display 114 can include a liquid crystal display (LCD), organic light emitting diode (OLED) display, plasma screen, or other kind of black and white or color display that allows the user to view and interpret information.

The controller 112 may also include circuitry of known construction to sense and record an amount of torque applied by the tool 100 to a work piece during a particular torque application. The controller 112 has volatile or re-writeable memory for storing recorded torque amounts for later retrieval and/or transmission to other devices.

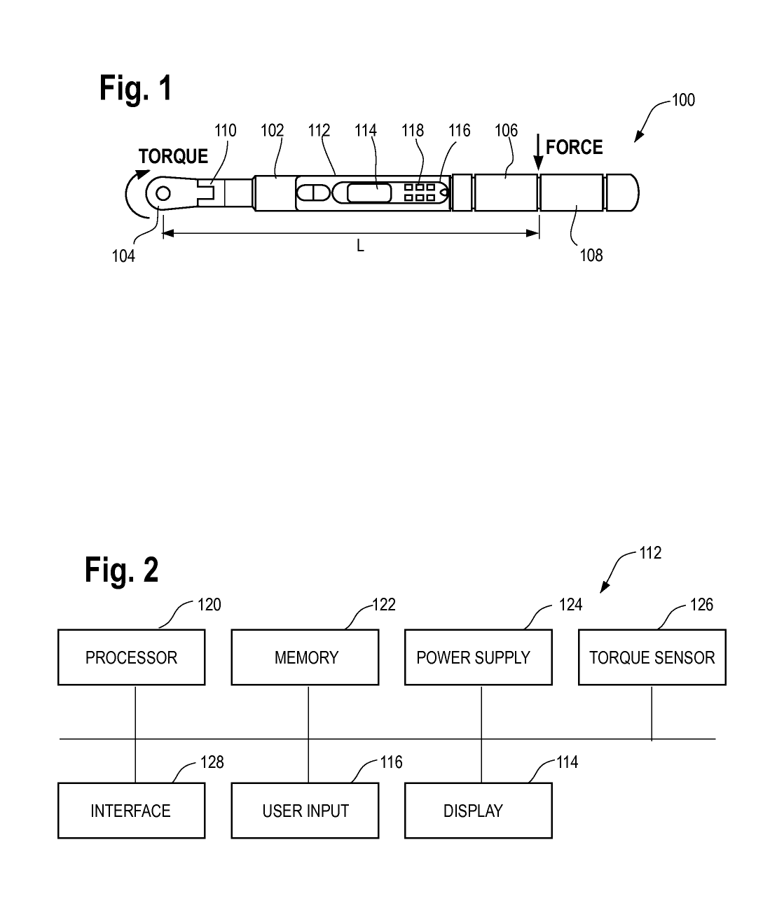

FIG. 2 illustrates a schematic functional block diagram of the controller 112 of the tool 100 in accordance with embodiment(s) of the present application. In an illustrative embodiment, the controller 112 includes one or more of a processor 120 for controlling operations of the controller 112, a memory 122 for storing data and/or computer programs, a power source 124, a torque sensor 126 to measure and sense a torque applied by the tool 100, an interface 128 for transmitting and/or receiving data relating to the tool 100 to external sources, and the user input interface 116 and the display 114. The above components of the controller 112 can be operably coupled together, directly or indirectly, by hardwired connections, wireless connections and/or other known coupling means.

The processor 120 facilitates communication between the various components of the tool 100 and controls operation of the electrical components of the tool 100. The processor 120 can be a special purpose or general type of processor or multiple processors, for example, a microprocessor, a single-core or a multi-core processor. In an illustrative embodiment, the processor 120 is configured to calculate a correction factor based on an offset length and adjust a torque measurement of the tool 100 so that the tool 100 presents an actual torque value on the display 114 or provides other feedback to the user when the desired amount of torque is reached, for example, through visual, audible or tactile well-known means.

In an illustrative embodiment, the memory 122 can store data or computer programs for use in the tool 100. For example, the memory 122 can store calibration factors, torque target values, offset lengths, and other such data. The memory 122 can also store an operating system for the controller 112 or other software or data that may be necessary for the tool 100 to function. Without limitation, the memory 122 can include non-transitory computer-readable recording medium, such as a hard drive, DVD, CD, flash drive, volatile or non-volatile memory, RAM, or other type of data storage.

The power source 124 may be, for example, a battery for powering operations of the controller 112 and the tool 100 in general. The power source 124 can be a source of electrical or mechanical power that can power the controller 112. In an illustrative embodiment, the power source 124 is a battery. However, the power source 124 can be other components that provide power, including a battery, fuel cell, engine, solar power system, wind power system, hydroelectric power system, a power cord for attachment to an electrical socket, or other means of providing power.

The torque sensor 126 measures a magnitude of torque applied by the tool 100. The torque sensor 126 may be a known mechanism capable of measuring torque. For example, the torque sensor 126 may be a strain gauge or load cell attached to a torsion rod.

The interface 128 can be a device capable of transmitting data from the tool 100 or capable of receiving data within the tool 100 from an external data source. By way of example, the interface 128 can be a hard wire connection, such as an insulated copper wire or optical fiber, or a radio transmission antenna, cellular antenna, infrared, acoustic, radio frequency (RF), or other type of wired or wireless interface capable of communicating with an external device.

Referring back to FIG. 1, the tool 100 is generally calibrated to measure a torque based on a preset lever arm distance or length (L). The length (L) is measured from a point of application of a force (also referred to herein as a calibration reaction point) to an axis of rotation of a center of the drive head 104, e.g. where the drive head 104 engages a work piece. Torque (τ) is defined as the cross product of a lever arm distance (d) and the force (F).

τ=d*F Equation 1

However, when an adapter or extension is coupled to the drive head 104, the distance (d) to the work piece is changed, by either decreasing or increasing. This change in distance is referred to herein as an offset or offset length. When using an adapter or extension, an adjustment to the calibrated torque measurement of the tool 100 is needed to obtain a correct torque reading because when the tool 100 was calibrated, the distance (d) was set to the length (L) and a calibration factor was calculated based on the length (L) and stored in the tool 100.

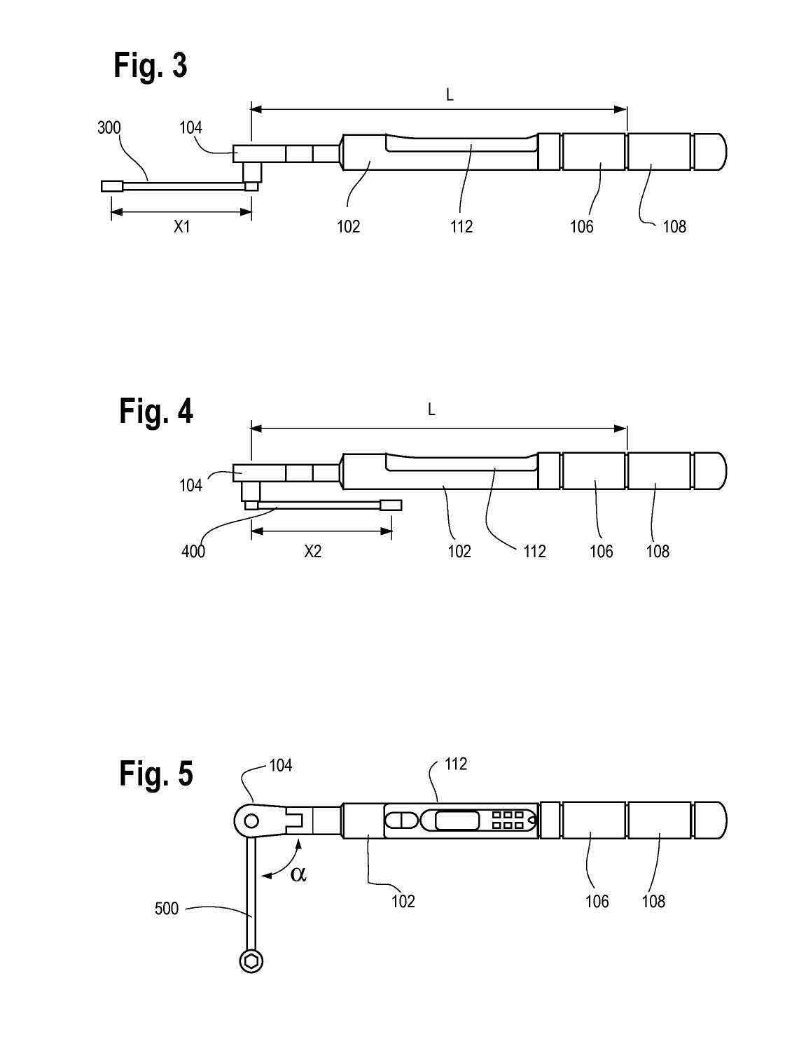

FIG. 3 illustrates the tool 100 with an exemplar extension 300 coupled to the drive head 104 of the tool 100. It will be understood that while a few exemplar adapters or extensions are shown and/or disclosed in the present application, the present application is not limited to any type of adapter or extension. In the exemplar embodiment shown in FIG. 3, the extension 300 increases the distance between the work piece and the point of application of the force to the tool 100 by an offset length X1 (d=L+X1), thereby causing a greater amount of torque to be applied to the work piece than would be measured by the tool 100 based on the original calibration factor.

FIG. 4 illustrates the tool 100 with another exemplar extension 400 coupled to the drive head 104 of the tool 100. In this exemplar embodiment, the extension 400 decreases the distance between the work piece and the point of application of the force to the tool 100 by an offset length X2, which is a negative value, (d=L−X2), thereby causing a lower amount of torque to be applied to the work piece than would be measured by the tool 100 based on the original calibration factor.

FIG. 5 illustrates the tool 100 with another exemplar extension 500 coupled to the drive head 104 of the tool 100. However, in this exemplar embodiment, the extension 500 is disposed at an angle of α (90°) relative to the drive head 104. The distance along the tool 100 to the work piece is therefore unchanged (d=L) and the amount of torque applied to the work piece and measured by the tool 100 would equal the calibrated amount of torque measured by the tool 100, since, in this case d=L.

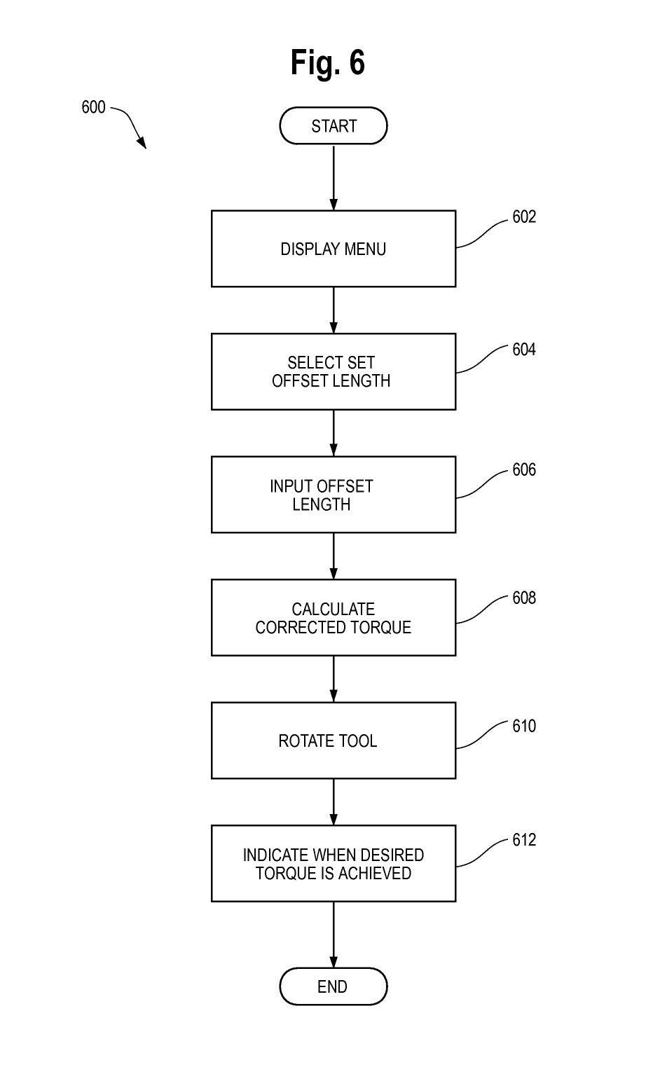

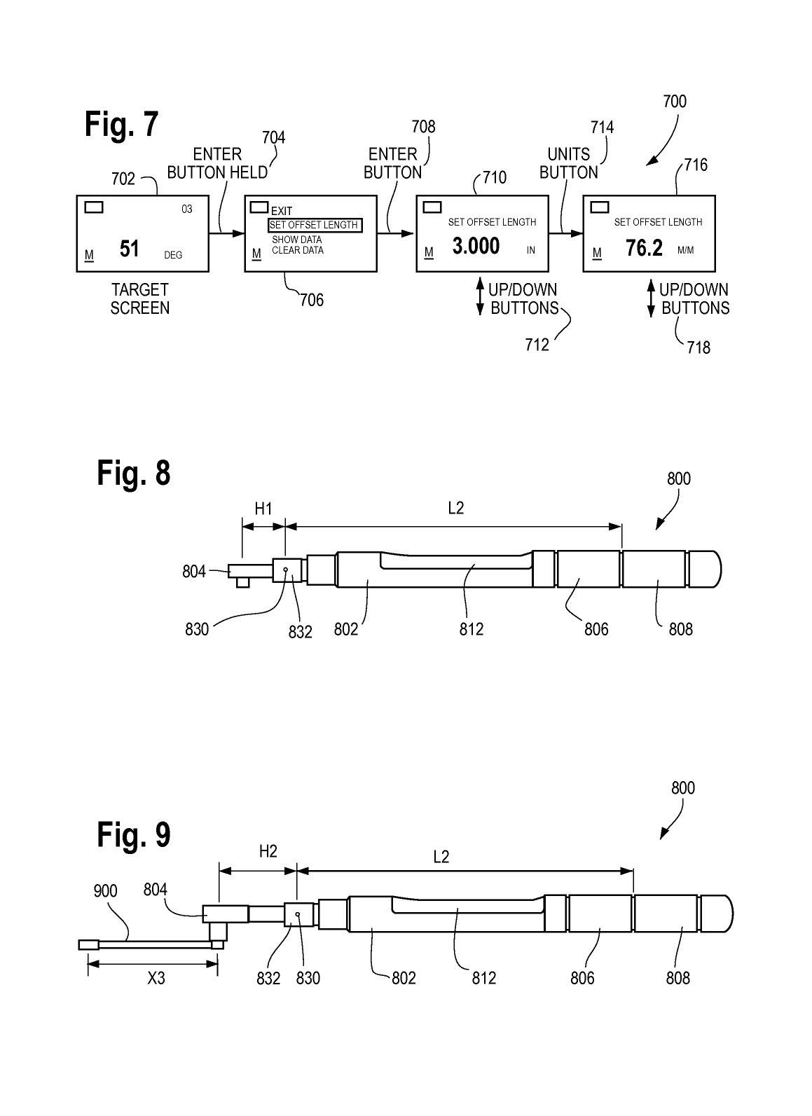

To compensate for the offset length X1 or X2, illustrated in exemplar FIGS. 3 and 4, the tool 100 allows a user to input the offset length into the tool 100 and the tool 100 adjusts the calibration of the tool 100 to cause the actual amount of torque to be measured by the tool 100. In another embodiment, the tool 100 allows the user to input a code adapted to identify the extension or adapter coupled to the tool 100, and the tool 100 can use a lookup table or other means to automatically determine the offset length to be used. With reference to FIGS. 6 and 7, a process 600 and a display sequence 700 for inputting an offset length and correcting torque measurement of the tool 100 to account for the offset length according to an illustrative embodiment of the present application is shown. Initially, a target screen 702 may be displayed on the display 114 of the tool 100. The target screen 702 may display a target torque value or angle of rotation for achieving a target torque value. A user may then hold an enter button of the user input interface 116, illustrated as 704.

The process 600 begins and proceeds to step 602, in which a menu is displayed on the display 114 of the tool 100. The menu being displayed may be, for example, the menu 706 illustrated in FIG. 7. The user selects “set offset length” in step 604, and as illustrated in FIG. 7 as 706. Once the “set offset length” is selected, the user selects enter, for example by pushing the enter button of the user input interface 116, illustrated as 708. The set offset length menu may then be displayed on the display 114, illustrated as 710. The user then inputs the offset length or length of the adapter or extension being used, illustrated as step 606. To input the offset length, the user may push one or more of up and down buttons of the user input interface 116, illustrated as 712, until a displayed value equals the desired offset length.

As illustrated in FIG. 7, the input menu 710 displays the offset length in inches. However, if it would be more convenient for the user, the units of the offset length can be altered to display the offset length in any other unit of measurement. For example, the user can push a units button of the user input interface 116, illustrated as 714, and the units of the displayed offset length can be changed to, for example, metric units of measurement. As illustrated, the display 114 is displaying the offset length in millimeters, illustrated as 716, upon pressing of the units button. With the offset length displayed in millimeters, the user can then push one or more of up and down buttons of the user input interface 116, illustrated as 718, until a displayed value equals the desired offset length. In another embodiment, inputting the offset length includes the user inputting a code specific to the adapter or extension, by either pushing number buttons or up and down arrows until the desired number is reached.

Referring back to FIG. 6, in response to the offset length being input, the tool 100, for example, the processor 120, adjusts the torque measurement of the tool 100 to correspond to the actual value of torque when the tool 100 is used in conjunction with an extension or adapter having the input offset length, illustrated as step 608. The user may then use the tool 100 with the extension or adapter, for example by rotating the tool to tighten or loosen a work piece, illustrated as 610. With the tool 100 reading the actual torque value, the tool 100 can indicate when a desired or set torque value is reached, such as providing visual, audible and/or tactile response to the user, as illustrated as step 612.

In an illustrative embodiment, for example, the processor 120 of the tool 100, adjusts the torque measurement of the tool 100 by calculating a correction factor (C_{f}), based on the length (L) that was used to calibrate the tool 100, e.g., the distance from the point of application of force to a center of the drive head, and the offset length, e.g., the distance from a center of the drive head to a work piece.

C_{f}=(L+offset length)/(L) Equation 2

Upon calculation of the correction factor (C_{f}), for example, the processor 120 of the tool 100, adjusts the torque measurement (τ) to correspond to a corrected actual torque value (τ_{cor}) using the following equation:

τ_{cor}=τ*C_{f} Equation 3

Referring to FIG. 8, in an illustrative embodiment, the tool may be a tool 800 with an interchangeable drive head 804. The tool 800 includes many of the same features as the tool 100 described above. For example, the tool 800 includes the drive head 804, a handle 802 having a shaft 806 and a grip 808, and a controller 812. The controller 812 may also include one or more of a processor, a memory, a power source, a torque sensor, an interface, a user input interface and a display, similar to the controller 112 described above.

However, instead of having a fixed drive head, for example as illustrated in the tool 100 of FIG. 1, the tool 800 includes a head locking pin 830 disposed in a receiving head 832. The interchangeable drive head 804 is inserted into the receiving head 832 and the locking pin 830 secures or couples the drive head 804 in the receiving head 832. It will be understood that the interchangeable drive head 804 can be releasably coupled to the tool 800 via other means without departing from the spirit and scope of the present application.

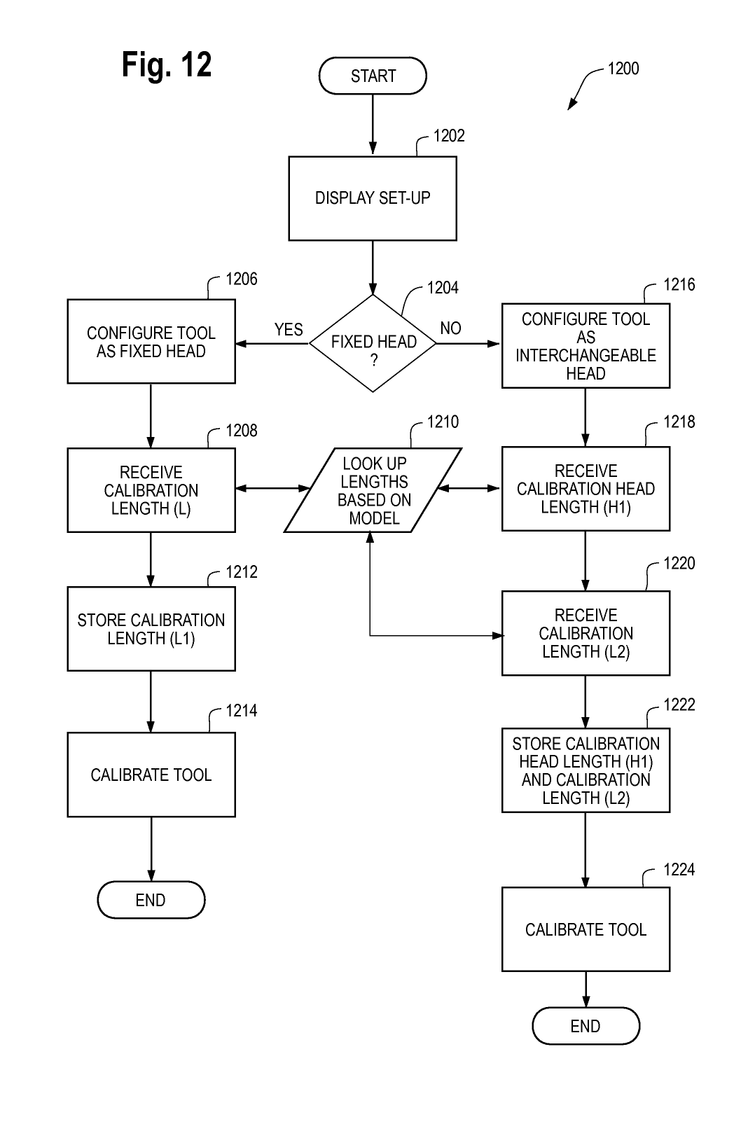

As illustrated in FIG. 8, the tool 800 has a fixed distance (L2) from a point of application of a force or calibration reaction point to a center of the head locking pin 830. However, since the drive head 804 is interchangeable and can have different lengths, the length of the drive head 804 may change. Thus, during calibration of the tool 800 a calibration head length (H1) is entered into the tool 800, as described in further detail below with reference to FIG. 12. In another embodiment, a code specific to the interchangeable drive head 804 can be input and the tool 800 can use a lookup table or other means to determine the calibration head length (H1) based on the specific code.

When the length of the drive head 804 is changed or the drive head 804 is replaced with a second drive head 804 having a different length, the distance (d) (referred to in Equation 1) to the work piece changes, by either decreasing or increasing. This change in distance causes the calibrated torque measurement of the tool 800 to be incorrect, which needs to be corrected. For example, FIG. 9 illustrates the tool 800 with a drive head 804 having a length (H2) greater than the length (H1) illustrated in FIG. 8, and an extension 900 coupled to the drive head 804 having a length (X3). In this embodiment, the drive head 804 and the extension 900 increase the distance between the work piece and the point of application of the force to the tool 800 by a head length of (H2−H1) and an offset length (X3). Thus, d=L2+X3+(H2−H1), thereby causing a greater amount of torque to be applied to the work piece than would be measured by the tool 800 based on the original calibration.

To compensate for the differing lengths, the tool 800 allows a user to input the current head length and an offset length into the tool 800, and the tool 800 adjusts the calibration of the tool 800 to cause the actual amount of torque to be measured and displayed by the tool 800.

In an illustrative embodiment, the tool 800, for example, the processor of the tool 800, adjusts the torque measurement of the tool 800 by calculating a correction factor (C_{f}), based on the length (L2) that was used to calibrate the tool 800, the calibration head length (H1), the new head length (H2), and the offset length (X3).

C_{f}=(L2+H2+offset length)/(L2+H1) Equation 4

Upon calculation of the correction factor (C_{f}), the processor of the tool 800 adjusts the torque measurement (τ) to correspond to a corrected actual torque value (τ_{cor}) using Equation 3 above.

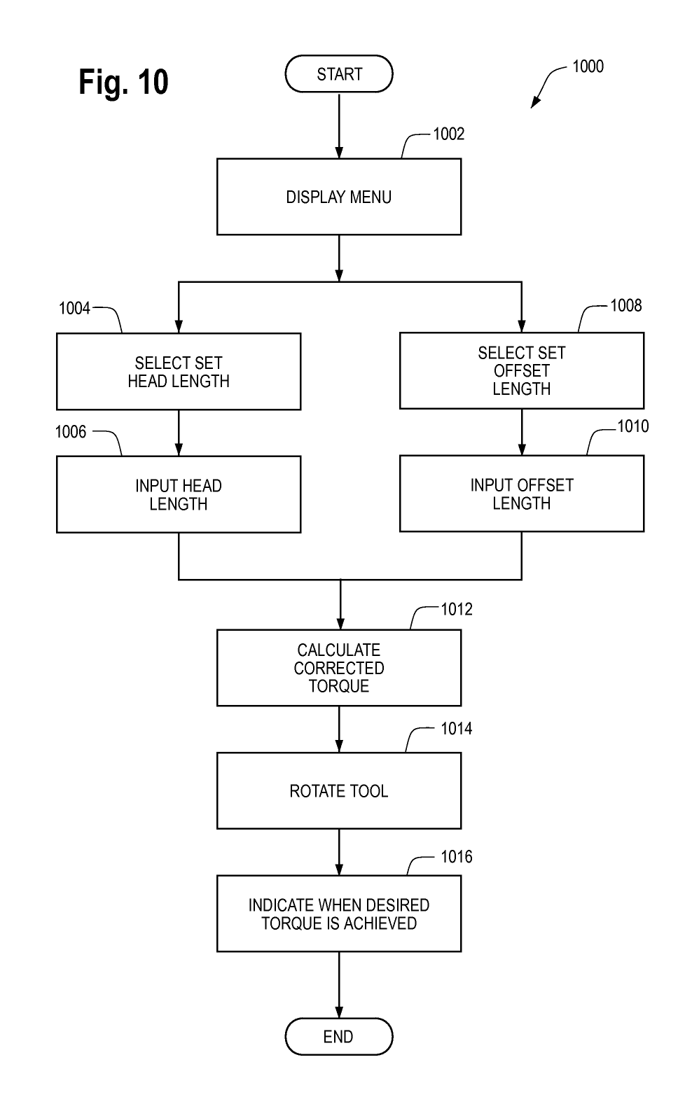

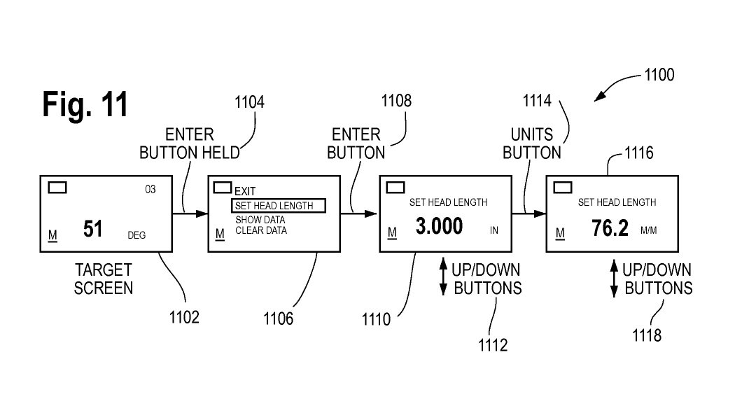

With reference to FIGS. 10 and 11, a process 1000 and a display sequence 1100 for inputting a current head length and optionally an offset length, and correcting a torque of the tool 800 according to an illustrative embodiment of the present application is described. Initially, a target screen 1102 may be displayed on the display of the tool 800. The target screen 1102 may display a target torque value or angle of rotation for achieving a target torque value. A user may then hold an enter button of the user input interface, illustrated as 1107.

The process 1000 begins and proceeds to step 1002, in which a menu is displayed on the display of the tool 800. The menu being displayed may be, for example, the menu 1106 illustrated in FIG. 11. The user selects “set head length” in step 1004, and as illustrated in FIG. 11 as 1106. Once the “set head length” is selected, the user selects enter, for example by pushing the enter button of the user input interface, illustrated as 1108. The set head length menu may then be displayed on the display, illustrated as 1110. The user then inputs the current head length, a sum of the current head length and an offset length of an adapter or extension being used, or specific code, illustrated as step 1006. To input the offset length, the user may push one or more of up and down buttons of the user input interface, illustrated as 1112, until a displayed value equals the desired head length or code.

As illustrated in FIG. 11, the input menu 1110 displays the head length in inches. However, as described above, the units can be altered to display the head length in other units of measurement. For example, the user can push a units button of the user input interface, illustrated as 1114, and the units of the displayed head length changes. As illustrated, the display is displaying the head length in millimeters, illustrated as 1116, upon pressing of the units button. With the head length being displayed in millimeters, the user can then push one or more of up and down buttons of the user input interface, illustrated as 1118, until a displayed value equals the desired head length or sum of the head length and the offset.

Referring back to FIG. 10, in an illustrative embodiment, the tool 800 may also be configure to receive an offset length input, for example as described above. In this embodiment, the user may also input an offset length or specific code by returning to the menu of the tool 800 and selecting “set offset length” in step 1008. Once the “set offset length” is selected, the set offset length menu may then be displayed on the display. The user then inputs the offset length or length of or specific code of the adapter or extension being used, illustrated as step 1010.

In response to the head length and optionally the offset length, or sum of the head length and the offset length being input, the tool 800, for example, the processor of the tool 800, adjusts the torque measurement of the tool 800 to correspond to the actual value of torque, for example using the Equations described above, when the tool 800 is used, illustrated as step 1012. The user may then use the tool 800 with the correct head length and the extension or adapter, for example by rotating the tool to tighten or loosen a work piece, illustrated as 1014. With the tool 800 reading the actual torque value, the tool 800 can indicate when a desired or set torque value is reached, illustrated as step 1016.

In an illustrative embodiment, the tools 100 and 800 may be configured as a fixed head tool or an interchangeable head tool to allow for the tools to function properly and display and operate the correct menus. FIG. 12 illustrates a set-up process 1200 in accordance with an embodiment of the present application. The process 1200 begins at step 1202, in which a set-up menu is displayed on the tools. The set-up menu allow the tool to be configured as a fixed head tool or an interchangeable head tool, illustrated as step 1204.

When the tool is a fixed head tool, the fixed head option is selected and the tool is configured as a fixed head tool, illustrated as step 1206. The tool then receives a calibration length, for example, the length (L) illustrated in FIG. 1, illustrated as step 1208. In one illustrative embodiment, a calibration length screen may be activated and the calibration length may be input into the tool using the user input interface. In another illustrative embodiment, the tool may be connected to an external database and look-up a calibration length based on a model of the tool, illustrated as step 1210. Upon receiving the calibration length, the tool stores the calibration length, for example in the memory of the tool, illustrated as 1212. The tool may then be calibrated based on the calibration length, illustrated as step 1214.

When the tool is an interchangeable head tool, the interchangeable head option is selected and the tool is configured as a interchangeable head tool, illustrated as step 1216. The tool then receives a calibration head length, for example, the length (H1) illustrated in FIG. 8, illustrated as step 1218. In one illustrative embodiment, a calibration head length screen may be activated and the calibration head length may be input into the tool using the user input interface. In another illustrative embodiment, the tool may be connected to an external database and look-up a calibration head length based on a model of the tool, illustrated as step 1210. The tool may also receive a calibration length, for example, the length (L2) illustrated in FIG. 8, illustrated as step 1220. Similar to the above, a calibration length screen may be activated and the calibration head length may be input into the tool using the user input interface or the tool may look-up the calibration length based on a model of the tool, illustrated as step 1210.

Upon receiving the calibration head length and optionally the calibration length, the tool stores the calibration lengths, for example in the memory of the tool, illustrated as 1222. The tool may then be calibrated based on the calibration head length and the calibration length, illustrated as step 1224.

As discussed above, the tools are electronic torque wrenches. However, the tools can be other mechanisms for imparting torque onto a work piece without departing from the spirit and scope of the present application. For example, and without limitation, the tools can be a ratchet wrench, open wrench, monkey wrench, torque screwdrivers, adjustable click-type torque instruments, torque reading instruments, torque drivers, open head torque wrenches, ratchets, or other tool capable of imparting torque to a work piece.

The matter set forth in the foregoing description and accompanying drawings is offered by way of illustration only and not as a limitation. While particular embodiments have been illustrated and described, it should be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A tool, comprising:
a drive head adapted to apply a torque to a work piece;
a handle extending from the drive head;
a torque sensor adapted to measure an amount of the torque being applied to the work piece by the drive head;
a user input interface adapted to receive an offset of an adapter; and
a processor in operable communication with the user input interface and the torque sensor, the processor adapted to adjust a measurement of the amount of torque to a corrected amount of torque based on the amount of torque being applied to the work piece and the offset.

2. The tool of claim 1, further comprising a display in operable communication with the processor, the display adapted to display the corrected amount of torque being applied.

3. The tool of claim 1, wherein the user input interface includes one or more buttons.

4. The tool of claim 1, further comprising a power supply adapted to supply power to the torque sensor, the processor, and the user input interface.

5. The tool of claim 1, further comprising a memory adapted to store a calibration factor, the offset, and a correction factor.

6. The tool of claim 1, wherein the user input interface is adapted to receive a current head length.

7. The tool of claim 6, wherein the processor is adapted to adjust the measurement of the amount of torque to the corrected amount of torque based on the amount of torque being applied to the work piece by the drive head, the offset, and the current head length.

8. The tool of claim 1, wherein the offset of the adapter corresponds to a code specific to the adapter used to reference the offset in a lookup table.

9. A tool, comprising:
a receiving head;
a handle extending from the receiving head;
an interchangeable drive head disposed in the receiving head;
a torque sensor adapted to measure an amount of torque being applied to the interchangeable drive head;
a user input interface adapted to receive a current head length of the interchangeable drive head; and
a processor in operable communication with the user input interface and the torque sensor, the processor adapted to adjust a measurement of the amount of torque to a corrected amount of torque based on the amount of torque being applied to the drive head and the current head length.

10. The tool of claim 9, further comprising a display in communication with the processor, the display adapted to display the corrected amount of torque being applied.

11. The tool of claim 9, wherein the user input interface includes one or more buttons.

12. The tool of claim 9, further comprising a power supply adapted to supply power to the torque sensor, the processor, and the user input interface.

13. The tool of claim 9, further comprising a memory adapted to store a calibration factor, the current head length of the interchangeable drive head, and a correction factor.

14. The tool of claim 9, wherein the user input interface is adapted to receive a length of an adapter or a code specific to the adapter corresponding to the length of the adapter in a lookup table.

15. The tool of claim 14, wherein the processor is adapted to calculate a correction factor based at least in part on the current head length and the length of the adapter.

16. A method of adjusting a torque measurement of a tool, comprising:
displaying a menu on a display of the tool;
receiving an offset of an adapter coupled to the tool via an interface of the tool;
calculating a correction factor based at least in part on the offset;
adjusting the torque measurement of the tool to a corrected torque measurement; and
indicating the corrected torque measurement to a user of the tool.

17. The method of claim 16, further comprising storing the correction factor on a memory of the tool.

18. The method of claim 16, further comprising receiving a current head length of an interchangeable head coupled to the tool via the interface of the tool.

19. The method of claim 18, wherein calculating the correction factor includes calculating the correction factor based at least in part on the current head length and the length of the adapter.

20. The method of claim 16, further comprising indicating when the corrected torque measurement reaches a preset torque setting.

21. The method of claim 16, wherein the step of indicating the corrected torque measurement to a user of the tool includes displaying the corrected torque measurement on the display.

22. The method of claim 16, wherein the step of receiving the offset of the adapter coupled to the tool via the interface of the tool includes receiving a code specific to the adapter and automatically obtaining the offset of the adapter based on the code from a lookup table.
